(19) United States
(12) Patent Application Publication
(10) Pub. No.: US 2008/0267197 A1
(43) Pub. Date: Oct. 30, 2008

(54) Circuit Assembly and Data Transmission Method

(76) Inventors: Mohammad-Jalil Ahmadyar, Landsberg am Lech (DE); Hannes Meyer, Stephanskirchen-Schlossb (DE); Klaus Negle, Landsberg am Lech (DE); Klaus-Peter Schwank, Martinsried (DE); Joachim Seifert, Kirchseeon (DE); Richard Vierthaler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/795,048

(22) PCT Filed: Jan. 4, 2006
(86) PCT No.: PCT/EP2006/050042

§ 371 Date: Apr. 4, 2008

(30) Foreign Application Priority Data
Jan. 11, 2005 (DE) 10 2005 001 258.2

(51) Int. Cl. H04Q 11/04; H04L 12/66

(52) U.S. Cl. 370/401

(57) ABSTRACT

A circuit assembly and an associated method are provided, which allow a user to autonomously influence the quality of the data that is to be transmitted, especially language data that is to be transmitted via the IP network, by controllingly addressing an adjusting unit via an evaluator and signalor when a selected coder-decoder is to be used.

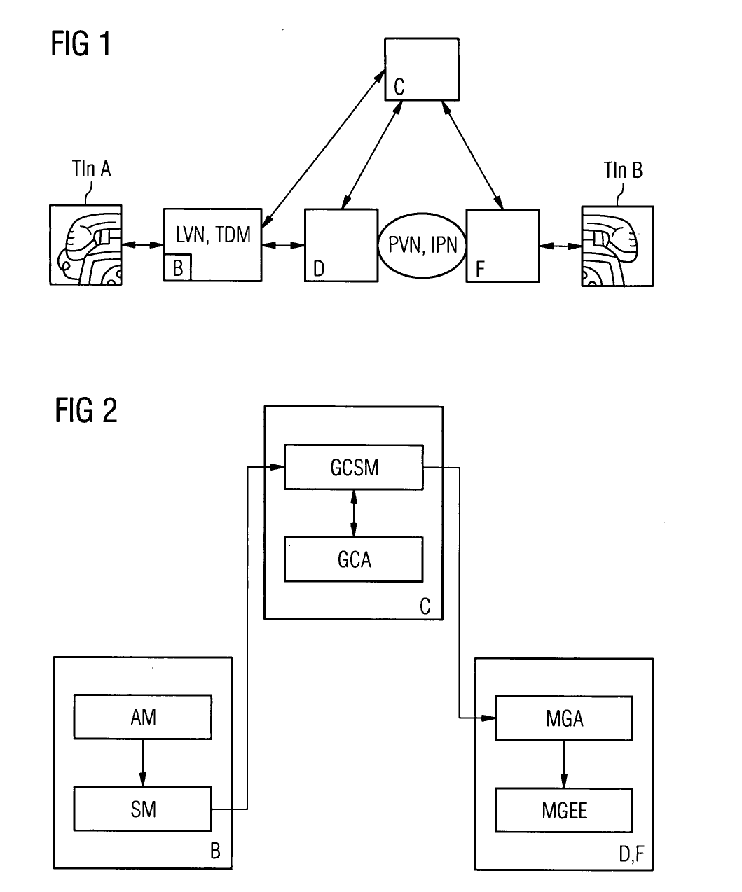

An ongoing integration of data, such as voice data and data files, previously transmitted separately in communication networks, increasingly demands a cross-network communication technology. In this case in addition to the real-time-capable, circuit-switched networks LVN traditionally used for voice services and voiceband data transmissions, the non-real-time capable packet-switched networks PVN previously provided for pure data transmission are increasingly being used. By contrast with packet-switched networks PVN, one channel is switched exclusively for information transmission in circuit-switched networks LVN. This satisfies the real-time characteristics required for the voice services and voiceband data transmission. Within the framework of this integration the services previously operated exclusively between end points in circuit-switched networks LVN will be handled both over packet-switched network sections and also on a cross-network basis between LVN and PVN end points, as depicted in FIG. 1. To this end, an interworking unit, referred to as a gateway D, F, is integrated at the transition between the two network types, i.e. at the periphery of the packet-switched networks PVN. A gateway D, F in this case generally provides a translation and/or code conversion function between the different types of network. For the data streams which originate in a circuit-switched network LVN a gateway in this case has the functionality of converting these into packets and delivering the packetized traffic to the packet-switched network PVN. For the data streams originating in the packet-switched network PVN this data conversion is run in the opposite direction. To establish a voice connection between two end points via an IP-based communication network IPN, the signaling for connection setup for example starting from a subscriber TlnA is sent via a circuit-switched network operating in a time-division multiplexing technology TDM to a media gateway controller C. The media gateways D and F connected to the media gateway controller C are controlled by this device, as shown in FIG. 1.

In such case the media gateways are sent the data needed for establishing communication by the media gateway controller e.g. using the media gateway control protocol or H.248 protocol.

The actual voice connection is routed via the media gateways D, F and the Internet Protocol-based network IPN. For transmission of voice data over the IP network codecs are used with which the voice data is converted into IP packets. Different codecs, such as G.711a/μ, G.723, G726 or G729 for example, can be used for this voice transmission. With these codecs the voice data transmitted in the circuit-switched network using time-division multiplexing is converted into data packets. ITU recommendation G.711 describes for example a transformation method for an audio compression and is used in the μ-Law and A-Law methods The compression method is based on a logarithmic conversion of an audio signal by means of a pulse code modulation with 13-bit resolution, with this being converted after quantizing by means of a logarithmic table into an 8-bit value. The human hearing characteristics are adapted by the logarithmization. The implementation of the recommendation in accordance with G.711 in the A-Law-method differs from that used in the μ-Law-method through different conversion tables.

The codecs to be used are preset by the network operator on the basis of physical circumstances or because of cost reasons. The disadvantage of this is that when circumstances change for example the quality of a voice data transmission may be reduced or transmission capacity may be blocked by a setting initially deemed as required.

The object of the present invention is to specify a circuit arrangement and a method with which a telecommunication subscriber can exert influence over the transmission of their digitized data to be transmitted.

The object is achieved by the features specified in claim 1 or 5.

The invention brings with it the advantage of influence being able to be exerted by a case-by-case and subscriber-individual selection of a codec.

The invention brings with it the advantage of enabling a telecommunications subscriber to select speech quality before or during a call or for a data transmission.

The invention brings with it the advantage of enabling the network operator to offer the end customer additional business models in this way, with which the end user can also exert influence on billing.

The invention is explained in greater detail below with reference to the following figures.

The figures show:

FIG. 1 a schematic diagram of a connection between two subscribers and

FIG. 2 a block diagram.

The invention provides a functionality in the environment of IP-based telecommunications networks which offers both the network operator and also the end customer added value. By offering a higher or lower compression the telecommunication subscriber can for example make use of a greater or lower bandwidth for data transmission by self-selection, which can also lead to different billing. One variant is embodied with first, second and third means.

FIG. 1 shows a simplified diagram of the interworking of individual modules between two subscribers TlnA and TlnB. The Figure depicts both a network with time-division multiplexing technology TDM and a network with packet data switching IPN based on an Internet technology. First and second media gateways D, F respectively form the gateway between the networks. These first and second gateways D, F are controlled by a gateway controller C which can also be referred to as a soft switch. The Internet Protocol-based network IPN is arranged between the first media gateway D and the second media gateway F.

In accordance with the invention, in this example starting from subscriber TlnA the media controller C is signaled over the time-division multiplex network TDM as to the codec to be used for transmission of the digitized voice data over the Internet Protocol-based communication network IPN. In this case a unit B in the time-division multiplexing TDM network accepts the codec requirement signaled by the subscriber TlnA and transmits this to the media controller C. There the signaled information is evaluated and transmitted to the respective media gateway D, F which then undertakes the actual codec selection. The following selections can be initiated starting from the subscriber in order to perform a codec change in the media gateway:

A codec to be used can be selected before each call. To this end the media controller C is to be notified by the calling subscriber, e.g. TlnA, as to the voice quality expected by the calling subscriber. Through the media gateway controller C, before the input of the telephone number of the subscriber to be called, this number can be notified to the media gateway controller C by subscriber TlnA. A manual input could also be replaced by a voice input. To this end, the terminal at subscriber TlnA converts for example the voice input of the subscriber into signaling corresponding to a manual input. Likewise the calling subscriber can exert influence on the voice quality via an IN service-controlled service, e.g. via Voice Box Dialog-Service or via a trigger point enabling interworking with other IN services. In addition the calling subscriber can also select a desired voice quality via an announcement dialog. A change of codec can also be undertaken independently of a call. In an embodiment of the invention a time-limited or permanent presetting for the subscriber, e.g. by using a further access code, is possible. A compression stage desired by the subscriber can be deactivated by the system on a case-by-case basis if technical peripheral conditions require this, thus for example if the distant end cannot offer the desired compression level or if the service does not permit a compression.

As an alternative to the individual specification of a call connection, a desired voice quality can be reached for each IN service by activating and deactivating the desired voice quality by Subscriber Controlled Input or by Internet Subscriber Controlled Input by means of keypad, Web-GUI or by activating and deactivating a desired speech quality by IN service.

In addition the speech quality can be influenced during an existing connection. This can be done for example by a Subscriber Controlled Input or by IN service by means of a midcall trigger. Since a subscriber mostly only detects during the call that the call quality of a voice call must have changed, he can communicate this to the media controller C via the time division multiplex unit B. This can be done by the subscriber briefly placing his call on hold and on a second signaling connection specifying his codec selection to the gateway by entering an access code. Likewise it is possible to execute the signaling between subscriber and time-division multiplex unit B over an ISDN channel. A recorded announcement can also be played to the subscriber via existing methods and a codec requirement requested using a dialog, before the subscriber returns to the other party in the call.

FIG. 2 shows individual modules of the unit depicted in FIG. 1. These units are the time-division multiplex switch B, the gateway controller C and also the media gateways D, F. Within the time-division multiplex switch B are shown a first evaluation module AM and also a first signaling module SM. Arranged in the media gateway controller C are a second signaling module GCSM and also a second evaluation module GCA. Shown in the media gateway D, F are a third signal evaluation unit MGA and a selection module MGEE. The following functions are executed with the individual units or modules respectively in this case:

First evaluation module AM:

The first evaluation module AM evaluates the subscriber signaling. It extracts the codec requirement of the subscriber and forwards this to a first signaling module SM.

First signaling module SM:

The first signaling module SM informs the media gateway controller C, by means of No. 7 signaling for example, that for the call between subscriber A and B codec in accordance with the subscriber request determined in the evaluation module AM is to be set.

Second signaling module GCSM:

The second signaling module GCSM in the media gateway controller extracts the codec request signaled by the first signaling module SM and forwards this to the second evaluation module GCA.

Second evaluation module GCA:

The second evaluation module GCA which can also be referred to as the provision module contains the central handling for the implementation of the request after a codec change. This comprises:

Database reconciliation of the request, under some circumstances by interrogating the gateways or adjacent media controllers or soft switches, selection of the best possible codec suited to requirements. Selecting the codec. To this end a message is sent to the media gateways D and F involved via the second signaling module GCSM

Third signal evaluation module MGA:

The third signal evaluation module MGA receives the message of the second signaling module GCSM and informs a selection unit MGEE in the respective gateway that a codec change is to be undertaken.

Selection unit MGEE:

The selection unit MGEE executes the codec change in the media gateway and acknowledges via the third signal evaluation module MGA and the second signaling module GCSM to the second evaluation module GCA, so that the latter can undertake the corresponding billing or reaction to the subscriber.

First, second and third means are depicted in the embodiment variant shown in FIG. 2, with the first means corresponding to the evaluation module AM arranged in the TDM Switch B, the second means to the provision module in the media gateway controller C and the third means MGEE to the selection modules arranged in the media gateway D and F. The individual means are each assigned signaling modules which, as specified above, communicate by means of data protocols.

1.-6. (canceled)

7. A circuit assembly for codec selection in data transmissions within a data transmission network, with the data to be transmitted being encoded with a codec, comprising:
a codec selector for selecting the codec wherein the selection of a codec undertaken by a subscriber.

8. The circuit assembly as claimed in claim 7,
wherein the codec selector includes a first evaluation module, a second evaluation module, and a third evaluation module,
wherein the first evaluation module evaluates signaling issued by the subscriber, and
wherein the second evaluation module provisions a codec corresponding to the requested codec.

9. The circuit assembly as claimed in claim 8, wherein the third evaluation module executes a change of codec initiated by the subscriber.

10. The circuit assembly as claimed in claim 8,
wherein a first signaling module is assigned to the first evaluation module and a second signaling module is assigned to the second evaluation module, and
wherein the first and second signaling modules communicating the codec change to each other under protocol control.

11. The circuit assembly as claimed in claim 10, wherein a TDM unit comprises the first evaluation module and the first signaling module and a media gateway controller comprises the second evaluation module and the second signaling module.

12. The circuit assembly as claimed in claim 8,
wherein the third evaluation module executes a change of codec initiated by the subscriber, and
wherein a first media gateway and a second media gateway each comprise the third evaluation module.

13. A method for codec section in data transmissions within a data transmission network, with the data to be transmitted being encoded by an encoder, comprising:
extracting a code selected by a subscriber;
forwarding the extracting request to a higher-ranking unit; and
settings made within a subscriber connection by the higher-ranking unit which select the codec requested by the user.

14. The method as claimed in claim 13, wherein the codec change is undertaken under protocol control.

15. A communication system for codec selection in data transmissions within a data transmission network, with the data to be transmitted being encoded with a codec, comprising:
a unit in a time-division multiplex network communicatively coupled to a subscriber, the unit receives a signal issued by the subscriber and extracts a codec requirement from the signal;
a gateway controller communicatively coupled to the unit, the controller receives the codec requirement from the unit and selects a codec suited to the codec requirement; and
a first media gateway and a second media gateway each communicatively coupled to the gateway controller, the first and second media gateways receive the selected codec and use the received codec to transmit that data between the first and second media gateways.
